(19) United States
(12) Patent Application Publication
(10) Pub. No.: US 2010/0299935 A1
(43) Pub. Date: Dec. 2, 2010

(54) Folding utility knife

(75) Inventor: Qiu Jian Ping, Hangzhou (CN)

Correspondence Address: COLLARD & ROE, P.C., 1077 NORTHERN BOULEVARD, ROSLYN, NY, 11576, US

(73) Assignee: Great Neck Saw Manufacturers, Inc.

(21) Appl. No.: 12/803,466

(22) Filed: Aug. 6, 2010

Related U.S. Application Data
(63) Continuation of application No. 11/986,725, filed on Nov. 26, 2007, now abandoned.

(51) Int. Cl. B26B 1/04; B26B 5/00

(52) U.S. Cl. 30/161; 30/155; 30/337

(57) ABSTRACT

A utility knife having a handle and a blade holder which is pivotally mounted on the handle for movement from an unfolded position to a folded position. The handle has a space adapted to receive the blade holder when the blade holder is in its folded position. The blade holder includes a main wall and guard wall mounted together and adapted to receive a blade therebetween and a locking lever pivotally mounted on the blade holder to lock the blade in place.

### BACKGROUND

This application is an improvement over U.S. patent application Ser. No. 11/800,684 filed May 7, 2007, the contents of which are incorporated herein by reference.

The present invention relates to a utility knife and more particularly to a folding utility knife in which the blade may be folded into the handle when the knife is not in use.

Folding utility knives have been in use for a number of years. In such knives the blades are mounted on a blade holder which is foldable within a handle when the knife is not in use. However, some of these folding utility knives have many movable parts which makes them difficult to use and expensive to manufacture. In addition, in some of these folding utility knives replacement of the blade is a complicated operation which may require the use of special tools.

### OBJECTS

The present invention overcomes these problems and has for one its objects the provision of an improved folding utility knife in which the blade holder may be easily folded into the handle.

Another object of the present invention is the provision of an improved folding utility knife in which the blade is held securely on the blade holder.

Another object of the present invention is the provision of an improved folding utility knife in which improved means are provided for replacing the blade on the blade holder.

Another object of the present invention is the provision of an improved folding utility knife which is simple to use and inexpensive to manufacture and maintain.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a side plan view of a utility knife made in accordance with the present invention.

FIG. 2 is a top plan view thereof.

FIG. 3A is a partial sectional side view showing the position of the parts when the folding utility knife is in its unfolded position.

FIG. 3B is a partial sectional side view similar to FIG. 3 showing the position of the parts when the folding utility knife in a partially folded position.

FIG. 3C is a partial sectional side view similar to FIG. 3 showing the position of the part when the folding utility knife in its fully folded position.

FIG. 4 is a side plan view of the blade holder of the present invention.

FIG. 5 is a sectional view taken along line 5-5 of FIG. 4 showing the blade locking means in its blade locking position.

FIG. 6 is a sectional view taken along line 6-6 of FIG. 3.

FIG. 7 is a sectional view similar to FIG. 4 showing the blade locking means in its blade releasing position.

FIG. 8 is a sectional view taken along the line 8-8 of FIG. 7.

FIG. 9 is an exploded view of the blade holder of the present invention.

FIG. 10 is a perspective view showing the position of the parts with the blade releasing mechanism in its blade locking position.

FIG. 11 is a perspective view similar to FIG. 10 showing the position of the parts with the releasing mechanism in its blade releasing function.

FIG. 12 is a perspective view similar to FIG. 10 showing the blade being replaced.

FIG. 13 is an enlarged sectional detail showing the position of the part when the blade is in its locked position.

FIG. 14 is an enlarged sectional detail showing the position of the parts when the blade is in its unlocked position.

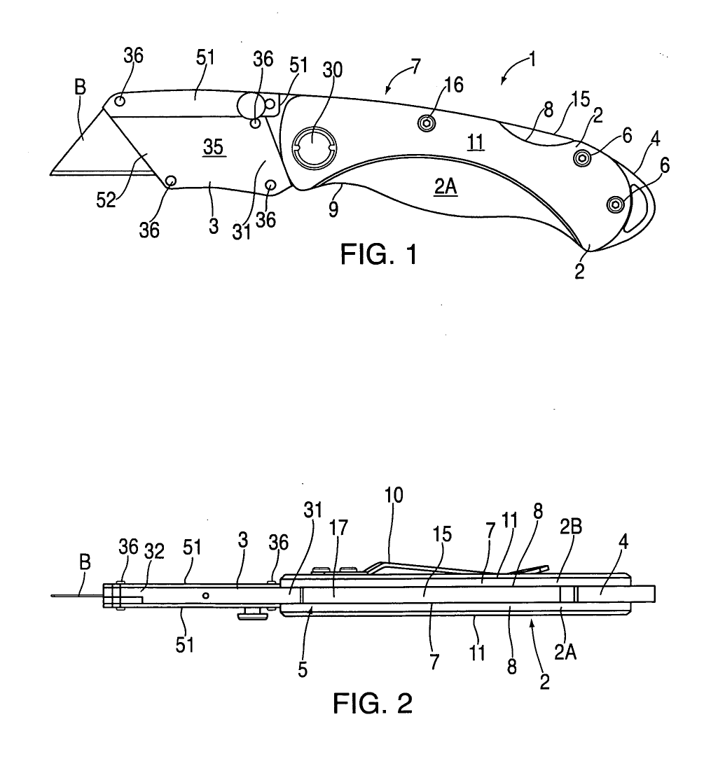

### DESCRIPTION

Referring to the drawings, the folding utility knife 1 of the present invention comprises a handle 2 and a blade holder 3.

The handle 2 comprises a pair of handle halves 2A and 2B each having an outer side wall 11, an upper edge 7 and a lower edge 9. A rear spacer 4 is provided between the handle halves 2A and 2B to maintain the handle halves 2A and 2B separated and to create a space 5 between handle halves 2A and 2B. The spacer 4 and the handle halves 2A and 2B may be held together by fasteners 6 which pass through the spacer 4 and the handle halves 2A and 2B in order to hold them together. The upper edge 7 of the handle halves 2A and 2B (i.e. the entire handle 2) has a finger notch 8 and the lower edge 9 of the handle halves 2A and 2B (i.e. the entire handle 2) may be undulated in order to permit the user's fingers to grip the handle 2. If desired, a clip 10 may be mounted on a side wall 11 of the handle halves 2A and/or 2B to permit the utility knife 1 to be fastened onto the user's belt or some other convenient place.

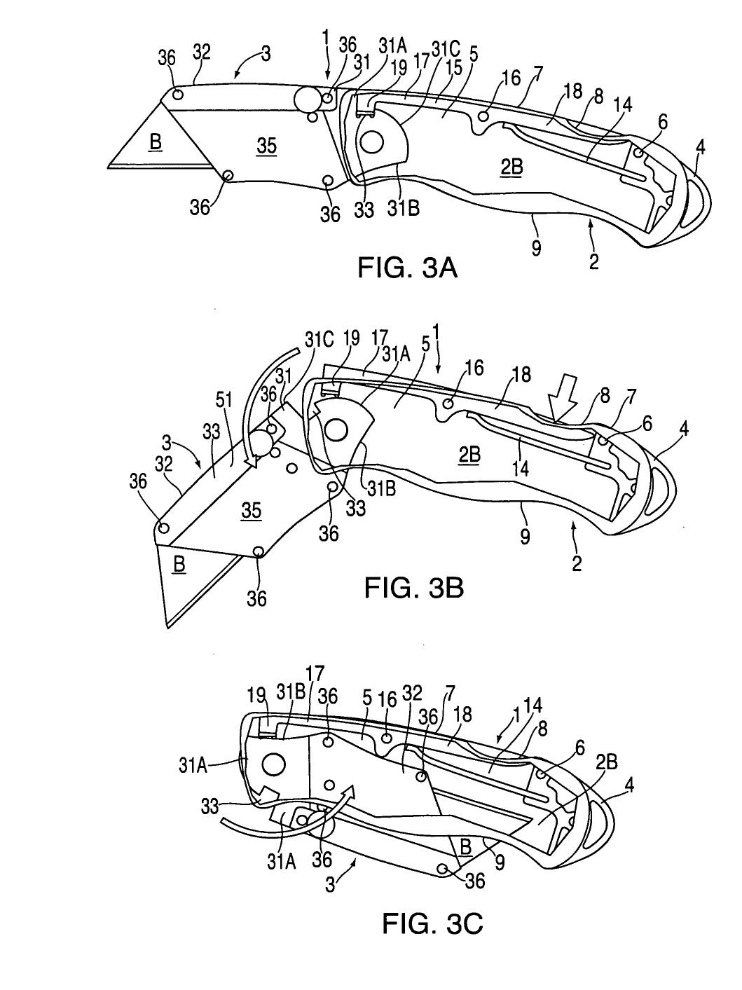

Interposed between the handle halves at 2A and 2B and along the upper edges 7 of the handle halves 2A and 2B there is provided a lock lever assembly 15 (FIGS. 3A to 3C) which is pivotally mounted between the handle halves 2A and 2B on a pivot pin 16 which extends through the two handle halves 2A and 2B and the lock lever assembly 15. The lock lever assembly 15 is preferably a two arm lever having front and rear arms 17 and 18, respectively. The front arm 17 is provided with a downwardly extending lock finger 19. Below the rear arm 18 of the lock lever assembly 15 there is provided a spring 14 which normally bears against the bottom edge of the rear arm 18 to force the rear arm 18 upwardly and the front arm 17 downwardly around the pivot 16 so that rear arm 18 protrudes above the notch 8. It will be seen that when the rear arm 18 of the lock lever assembly 15 is pressed down manually through the notch 8 against the action of spring 14, the front arm 17 will be raised.

The blade holder 3 of the present invention comprises a rear end 31 and a front end 32.

The rear end 31 of the blade holder 3 has rear edge 31A, bottom edge 31B and upper edge 31C. The blade holder 3 is pivotally mounted in the space 5 between handle halves 2A and 2B on a pivot pin 30. The upper edge 31C of the rear end 31 has a lock groove 33 into which the downwardly extending lock finger 19 of the lock assembly 15 is adapted to enter when the blade holder 3 is in its extended or unfolded position.

The blade holder 3 comprises a thin wall 34 and a thin guard wall 35 which are held together by any well known means such as by welding them together or by fastening them together with suitable fasteners 36. If desired they may be made of one piece and integral with each other. The main wall 34 is thinner than the upper edge 31C to form an upper hollow control area 50 and a lower slit 52 therebelow which is adapted to receive and hold a blade B between walls 34 and 35. The blade B preferably has a lower cutting edge 37 and spaced notches 38 in its upper edge 39. The blade B is adapted to slide in and out of a slit 52 formed between the walls 34 and 35.

A blade lock lever arm 45 is pivotally mounted within the groove 50 on a pivot pin 46 pivotally mounted on upper edge 31C for movement in a plane perpendicular to the plane of the side walls 34 and 35. A pair of opposed panels 51 are mounted to enclose the upper area 50 on opposed sides of the upper edge 31A. The blade lock lever 45 has a front arm 47 and a rear arm 48 with a downwardly extending blade finger 49 depending from its front arm 47 (FIGS. 13 and 14). The blade finger 49 has re-entrant tip 43 adopted to enter a groove 38 on the blade B.

When the blade lock lever 45, is pivoted around pivot 46 in one direction the tip 43 of its blade finger 49 will enter into one of the upper notches 38 on blade B in order to lock the blade B in place. When it is desired to remove and replace the blade B the blade lock arm 45 is pivoted in the opposite direction to move the tip 43 of the blade finger 49 out of the blade notch 38 to release the blade B and permit it to be slid out of the slit 52. The rear arm 48 of the blade lock lever 45 has a plate 60 depending therefrom. A spring 61 is mounted on one side of the plate 60 the opposite side has a finger button 42 which extends through one of the plates 31. Normally the spring 61 biases the lever on 45 so that the front arm 47 is located toward blade B with the tip 43 of the lock finger 49 entered into the notch 38 in the blade B. When the finger button 42 is pushed inwardly against the bias of the spring 61, the rear arm 48 of the lock lever 45 is in a pushed-in position thereby moving the front arm 47 away from blade B and the finger tip 43 out of the notch 38 in the blade. It will be understood that rather than a single blade finger 49, as shown, it is within the purview of the present invention to have a plurality of blade fingers 47 to enter the notches 38 in the blade.

In operation, the utility knife 1 is placed in its operative unfolded position with the blade holder 3 unfolded and ready to be used. The blade B is held in the slit 52 by the top 43 of the blade finger 47 of the blade lock arm 45 (which is in its normal position) extending into a notch 38 in the top edge 39 of the blade B. The lock finger 19 of the front arm 17 of the lock lever assembly 15 is in its lower position (because of the pressure of spring 14 on rear arm 18) and is positioned in the groove 33 in the blade holder 3 in order to hold the blade holder 3 in its unfolded position. The rear arm 18 of the lock lever assembly 15 is in its raised position and protrudes above the finger notch 8 at the top edge 7 of the handle 2.

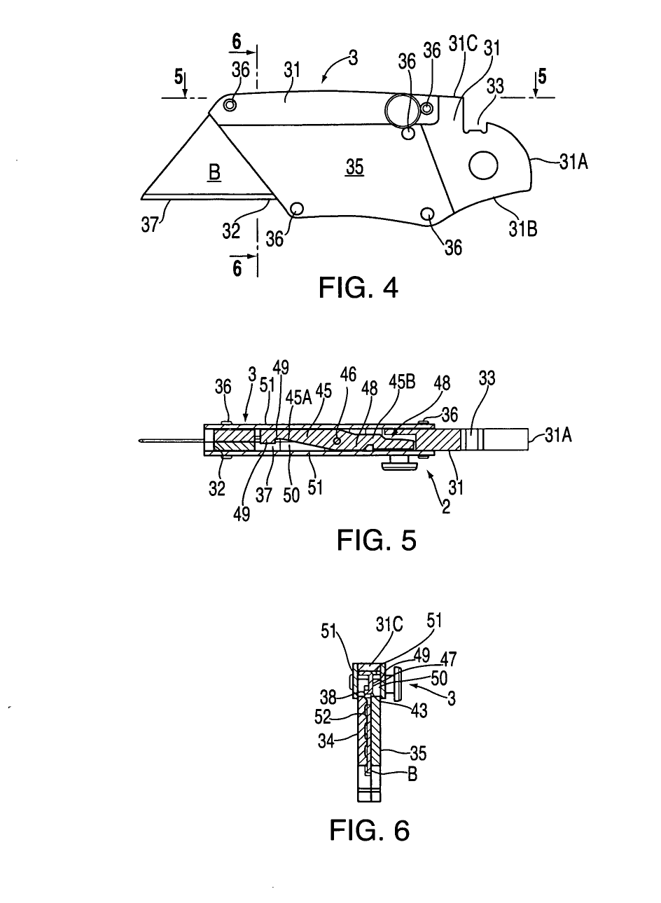

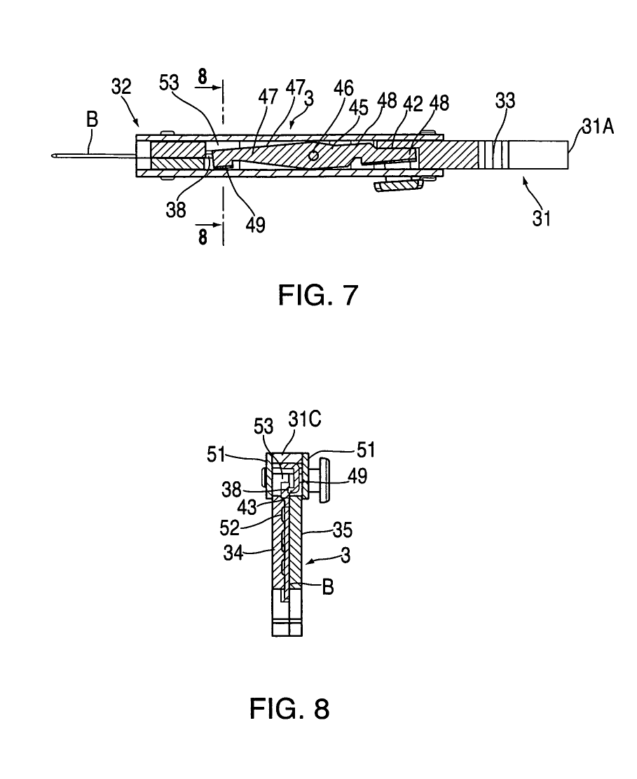

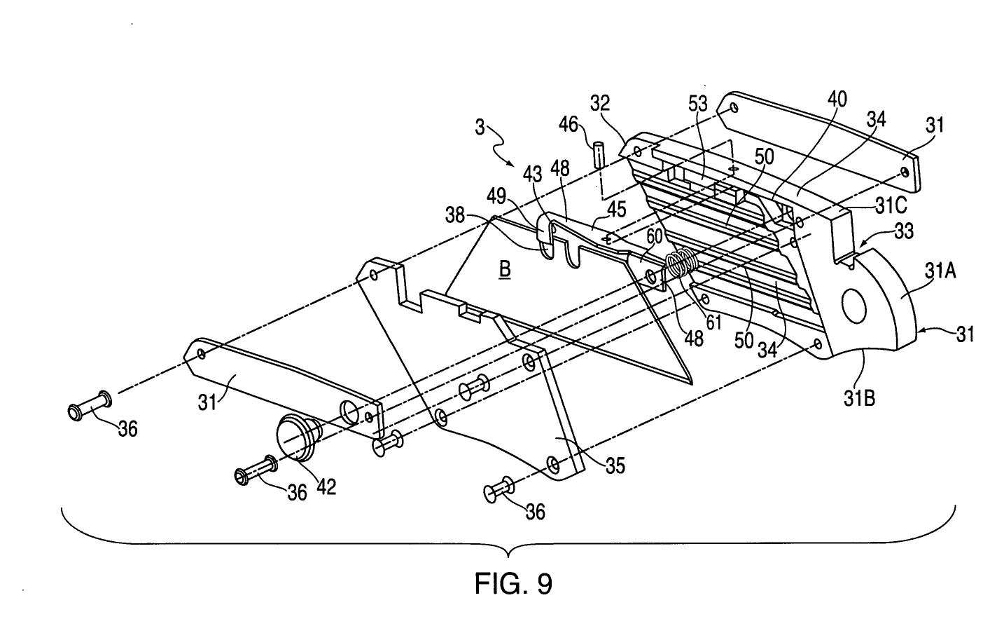

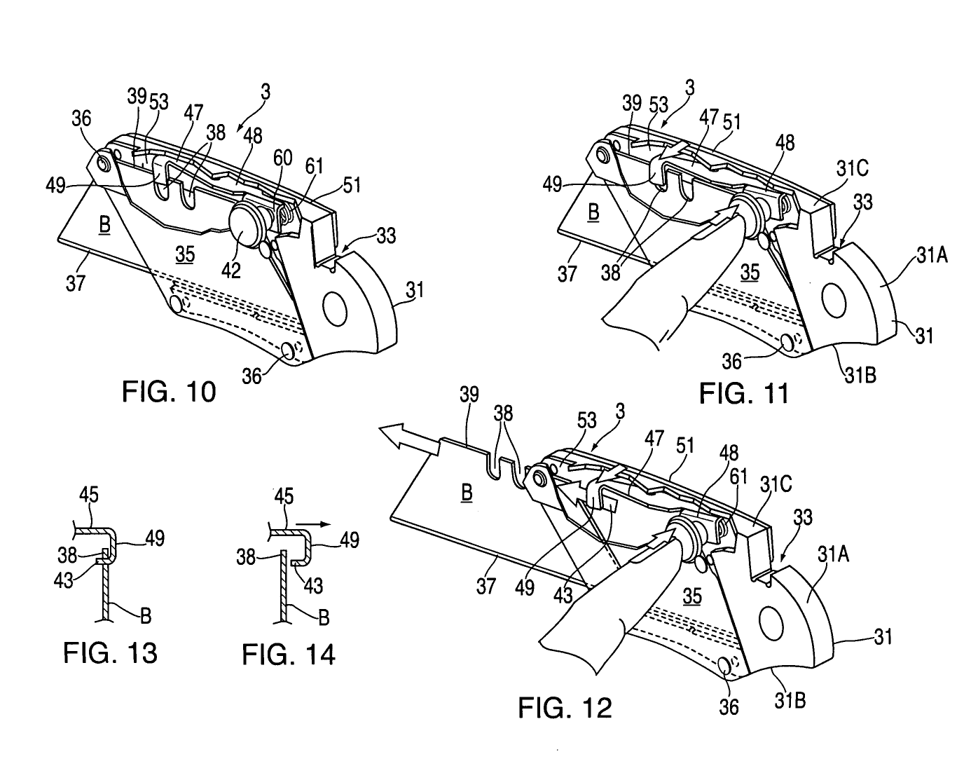

When it is desired to place the utility knife 1 into its folded inoperative position, the rear arm 18 of the lock lever assembly 15 is pressed down manually through the notch 8 against the bias of the spring 14. This causes the front arm 17 of the lock lever assembly 15 to be raised thereby moving the lock finger 19 out of the groove 33 to release the blade holder 3 and permit it to pivot downwardly around the pivot pin 30 (FIG. 4). This may be accomplished by pushing down on the finger knob 41. The blade holder 3 is then pivoted down completely into the space 5 between the handle halves 2A and 2B (FIG. 5). When pressure on rear arm 18 is released, the spring 14 moves the rear arm 18 back to its original raised position by the tension of the spring 14. This causes the lock finger 19 to bear against the button edge 31 B of the blade holder 3 thereby holding the blade holder 3 in its folded position.

When it is desired to use the blade B the reverse procedure is followed. The blade holder 3 is pivoted in the opposite direction. It may be desirable for the rear arm 18 of the lock lever assembly 5 to again be depressed manually to assist in unfolding the blade holder 3. The blade holder 3 is continued to be rotated counter-clockwise (as seen in FIG. 4) until the lock finger 19 of the front arm 17 enters into the groove 33 in the rear end 31 of the blade holder 3 in order to hold the blade holder 3 in its extended position.

When it is desired to replace a blade B the blade holder 3 is placed in its unfolded position (as shown in FIGS. 3A to 3C) and the blade lock arm 45 is moved in one direction around pivot 46 by means of finger tab button 42 against the bias of spring 61 thereby moving the tip 43 of the blade finger 49 out of the notch 38 in the upper blade edge 39 of the blade B to release the blade B. The blade B can then be moved out of the blade holder 3 through slit 52 and a new blade B can be placed therein through the slit 52. When this occurs the push button 42 is released so that the blade lock arm 45 moves the top 43 of the blade finger 49 into the notch 38 in the blade B to lock the blade B in place.

As many and varied modifications of the subject matter of this invention will become apparent to those skilled in the art from the detailed description given hereinabove, it will be understood that the present invention is limited only as provided in the claims appended hereto.

1-13. (canceled)

14. A utility knife comprising a handle and a blade holder, said blade holder being pivotally mounted on said handle for movement from an unfolded position to a folded position, said blade holder comprising a main wall structure and a guard wall structure mounted together, said wall structures being adapted to receive a blade therebetween, said blade being removable from between said wall structures when in its inoperative position and being mounted between said wall structure when in its operative position, a blade lock on said blade hold to hold said blade between said wall structures, said blade lock comprising a blade lock lever being pivotally moveable on said blade holder in a direction substantially perpendicular to the said wall structures, said wall structures being mounted together and having a slit therebetween adapted to receive the blade, said blade being substantially stationary and immovable lengthwise relative to said wall structures, when said blade is in its operative position and said blade lock lever being located wholly within the confines of the wall structure at all times.

15. A utility knife as set forth in claim 14 wherein said blade lock lever is mounted for pivotal movement relative to said wall structures from an open position to a closed position.

16. A utility knife as set forth in claim 15 wherein said blade lock lever comprises a blade finger extending therefrom and having a position adapted to enter a notch in the blade to hold the blade in place when the blade lock arm is in said closed position.

17. A utility knife as set forth in claim 16 wherein said blade lock lever is adapted to move in a space in said blade holder between said wall structures.

18. A utility knife as set forth in claim 17 wherein said wall structures comprise opposed thin panels attached to opposed side walls and extending above a top edge of the side walls.

19. A utility knife as set forth in claim 18 wherein said blade holder comprises a rear end, and a front end, said front end comprising said wall structures, said rear end being pivotally mounted to said handle and having upper and bottom edges.

20. A utility knife as set forth in claim 19 wherein said blade lock lever has a finger tab extending therefrom.

21. A utility knife as set forth in claim 20 wherein a spring is provided to bias said blade lock lever to its closed position.

22. A utility knife as set forth in claim 21 wherein said handle comprises a pair of spaced handle halves adopted to form a space therebetween for receiving at least a portion of said blade holder when in its folded position and wherein said handle has a pivoted lock lever assembly mounted in the said space in the handle and wherein said lock lever assembly has a front arm and a rear arm and a lock finger extending from its front arm.

23. A utility knife as set forth in claim 22 wherein said rear end of the blade holder has a groove therein adapted to receive said lock finger when the blade holder is in its unfolded position.

24. A utility knife as set forth in claim 23 wherein spring means are mounted beneath the rear arm of the lock lever assembly to bias the rear arm upwardly and to bias the front arm downwardly to permit the lock finger to enter the groove, whereby depressing the rear arm against the tension of the spring means will cause the front arm to rise and the lock finger to move out of the groove permitting the blade holder to pivot relative to the handle from an unfolded position to a folded position into the space in the handle.

25. A utility knife as set forth in claim 24, wherein the handle has a notch in its top edge and wherein the rear arm protrudes above the notch whereby depression of the rear arm at the notch permits the front end to be raised upwardly and cause the lock finger to move out of the lock groove.
